(19) United States
(12) Patent Application Publication
(10) Pub. No.: US 2004/0174001 A1
(43) Pub. Date: Sep. 9, 2004

(54) Generator carrier for a driver's gas bag module and function module for a steering wheel of a motor vehicle

(75) Inventors: Dominik Schuetz, Waldaschaff (DE); Dieter Rumpf, Roedermark (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 10/791,176

(22) Filed: Mar. 2, 2004

(30) Foreign Application Priority Data
Mar. 3, 2003 (DE) 203 03 388.4

(51) Int. Cl. B60R 21/20

(52) U.S. Cl. 280/728.3; 280/731

(57) ABSTRACT

A generator carrier for a driver's gas bag module has an outer wall. On the outer wall at least one insert contour is provided for the arrangement of a function module. A function module for a steering wheel of a motor vehicle has a plug-in contour for fastening to a component of the steering wheel.

### TECHNICAL FIELD

The invention relates to a generator carrier for a driver's gas bag module. The invention further relates to a function module for a steering wheel of a motor vehicle. The invention further relates to an assembly of a generator carrier and a function module, and also to a steering wheel for a motor vehicle.

### BACKGROUND OF THE INVENTION

Gas generator carriers are sheet metal or plastic parts which, figuratively, form the bridge between the gas generator of a gas bag module and the steering wheel skeleton. The gas generator is usually mounted directly on the gas generator carrier, and the latter is connected directly or indirectly with the steering wheel skeleton.

Modern steering wheels are also increasingly being equipped with switches, e.g. for operating an audio system, a car telephone or an on-board computer, and with electronic modules in which, for example,, electric circuits are housed for signal processing. The switches are arranged in switch modules, which like the electronic modules are fastened to the steering wheel skeleton as separate components by means of intermediate plates or the like, which makes the installation expensive and renders a precise positioning relative to other adjoining components, in particular to the generator carrier, more difficult.

It is an object of the invention to simplify the switch and electronic modules and to facilitate the exchange of these function modules.

### BRIEF SUMMARY OF THE INVENTION

According to the invention, a generator carrier for a driver's gas bag module has an outer wall, on the outer wall at least one insert contour being provided for the arrangement of a function module. The generator carrier according to the invention therefore enables a simple attaching of one or more function modules with an installation position of the modules which is given in a defined manner. Thereby, an improvement is achieved with regard to the accuracy of position of the function modules on the generator carrier and relative to adjoining components of the steering wheel such as the covering cap of the gas bag module, the steering wheel spokes etc. In addition, as a whole the assembly of the steering wheel is simplified. The construction of the generator carrier according to the invention provides the possibility of combining the generator carrier and the function modules into a pre-assembled structural unit. Additional installation parts for the function modules can be dispensed with, so that the number of components is reduced and the structural space which is available in the steering wheel is better utilized.

According to a further aspect of the invention, a function module for a steering wheel of a motor vehicle has an insertion contour for fastening on a component of the steering wheel. The plug-in contour makes possible a simple arrangement, in precise position, of the function module on the steering wheel.

The invention further provides an assembly of a generator carrier according to the invention and a function module according to the invention. One embodiment of the assembly according to the invention proves to be particularly advantageous, in which a cable harness is laid inside the generator carrier, which is guided into the region of the insert contour, one end of the cable harness being bared and fastened in the region of the insert contour, and in which a contact lead of the function module is guided into the region of the plug-in contour, one end of the contact lead being bared and fastened in the region of the plug-in contour. Through this development, the wiring of the function module is substantially simplified, because an electric connection is automatically brought about with the insertion of the function module. Additional work for contacting is no longer necessary.

The invention also provides a steering wheel for a motor vehicle with an assembly according to the invention.

Advantageous designs of the connection of the function modules to the steering wheel, in accordance with the invention, will be apparent from the sub-claims.

### BRIEF DESCRIPTION OF THE DRAWINGS

FIG. 1 shows a perspective exploded view of an assembly according to the invention, without cabling;

FIG. 2 shows a perspective view of the assembly of FIG. 1 in an assembled state with cabling, according to a first embodiment of the invention;

FIG. 3 shows a diagrammatic sectional view of a generator carrier according to the invention in the region of the outer wall, according to a second embodiment of the invention;

FIG. 4 shows a diagrammatic sectional view of a switch module according to the second embodiment of the invention; and

FIG. 5 shows a sectional view of the generator carrier of FIG. 3 and of the switch module of FIG. 4 in an assembled state.

### DETAILED DESCRIPTION OF THE PREFERRED EMBODIMENTS

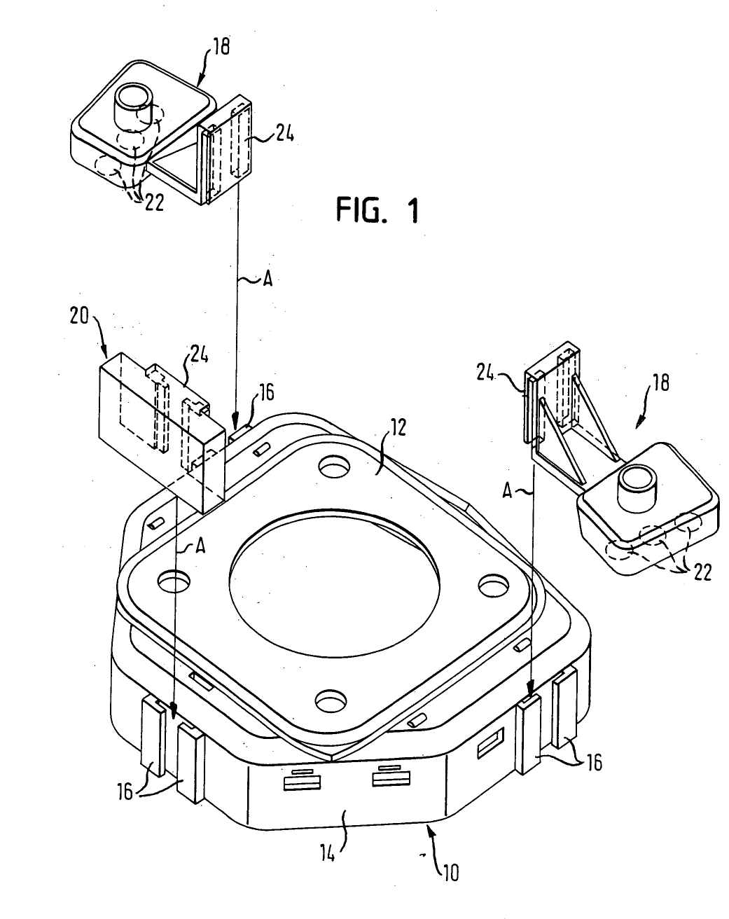

In FIG. 1 a generator carrier is illustrated for a gas bag module, which is intended for installation into a steering wheel of a motor vehicle. On the generator carrier 10, which may consist, for example, of plastic or sheet steel, a gas generator for filling a gas bag is installed prior to incorporation of the generator carrier 10. FIG. 1 shows, in relation to the driver's view onto the steering wheel incorporated in the motor vehicle, a rear view (i.e. the side facing away from the driver) of the generator carrier 10. The generator carrier 10 is constructed substantially in a cup shape with a base plate 12 and an encircling outer wall 14. Insert contours 16 are formed on the outer wall 14 externally, in relation to the view of the driver, on the left, right and lower side.

In FIG. 1 in addition several function modules 18, 20 are shown, namely two switch modules 18 with button switches 22 and one electronic module 20. The function modules 18, 20 have T-shaped plug-in contours 24 matching the insert contours 16, so that the function modules 18, 20 can be simply fixed onto the generator carrier 10 in accordance with the arrows A. To secure the connection between the function module and the generator carrier, a suitable detent mechanism (not illustrated) is respectively provided. In the embodiment shown in FIG. 1, in relation to the view of the driver, a switch module 18 is provided in each case on the left and on the right edge and also an electronic module 20 on the lower edge of the generator carrier 10; however, other configurations are also possible.

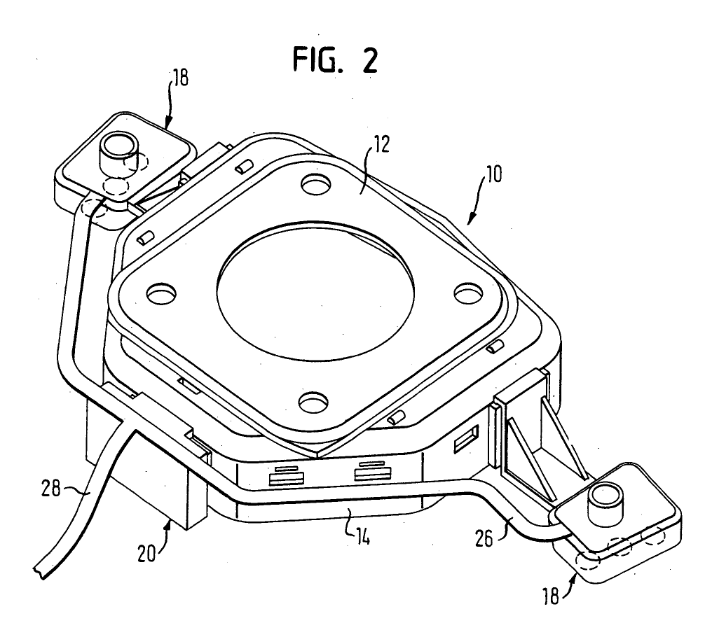

FIG. 2 shows the assembly of generator carrier 10 and function modules 18 in the state when being assembled and wired. The function modules 18, 20 are connected with the electronic module 20 by means of a cable harness 26, preferably a flat band cable, guided on the outer wall 14 of the generator carrier 10. The electronic module 20 itself is connected via a further cable harness 28 with a unit for controlling corresponding vehicle facilities, for example.

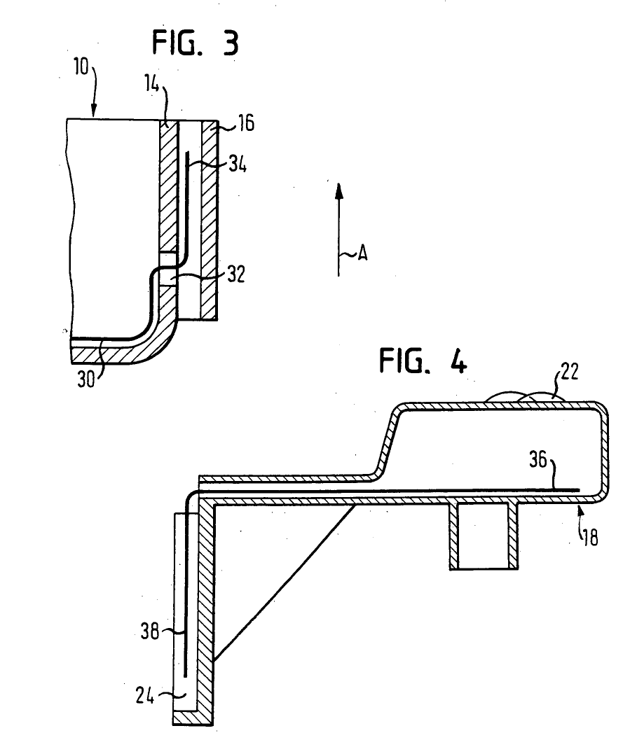

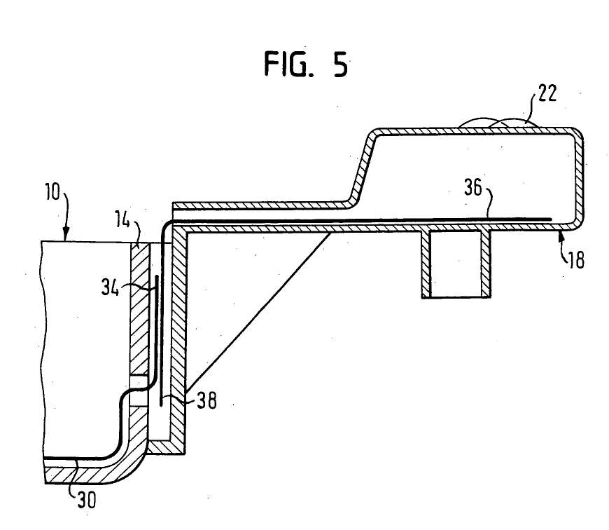

FIGS. 3 and 5 relate to the assembly shown in FIG. 1, but with a different wiring from the one illustrated in FIG. 2. In FIG. 3 it can be seen that a flat band cable 30 connected with the electronic unit 20 (not shown in FIGS. 3 to 5) is laid inside the generator carrier 10. The cable 30 is guided through an opening 32 in the outer wall 14 of the generator carrier 10 into the region of the insert contour 16, where the end 34 of the cable 30 is fastened. However, the cable 30 can also be laid on the outer wall 14 and be guided from there into the region of the insert contour 16. In the switch module 18 illustrated in FIG. 4, a contact lead 36 is guided into the region of the plug-in contour 24. The end 38 of the contact lead 36 is fastened in the region of the plug-in contour 24 and is bared, like the end 34 of the cable 30. The ends 34, 38 of the cable 30 and of the contact lead 36, respectively, are arranged so that on fixing of the switch module 18 onto the generator carrier 10, automatically an electric connection is produced, similar to a telephone socket/plug connection. The electric connection of the cable 30 with the electronic module 20 can be realized in the same way.

Instead of the use of cables and contact leads, electrical paths can also be vaporized three-dimensionally onto the (plastic) generator carrier 10 or onto the housings of the function modules 18, 20 (in accordance with the so-called MID technique) and bared in the region of the contact points.

The connection of the function modules 18, 20 according to the invention makes possible a simple exchange of the function modules 18, 20 for example in a case of warranty.

1. A generator carrier for a driver's gas bag module, the generator carrier (10) having an outer wall (14), characterized in that on the outer wall (14) at least one insert contour (16) is provided for the arrangement of a function module (18, 20).

2. The generator carrier according to claim 1, characterized in that on the outer wall (14) a cable harness (26) is guided for the electrical connection of the function module (18, 20).

3. The generator carrier according to claim 1, characterized in that inside the generator carrier (10) a cable harness (30) is laid, which is guided into the region of the insert contour (16).

4. The generator carrier according to claim 2, characterized in that one end (34) of the cable line (30) is bared and fastened in the region of the insert contour (16).

5. The generator carrier according to claim 3, characterized in that one end (34) of the cable line (30) is bared and fastened in the region of the insert contour (16).

6. A function module for a steering wheel of a motor vehicle, characterized in that the function module (18, 20) has an plug-in contour (24) for fastening to a component of the steering wheel.

7. The function module according to claim 6, characterized in that the function module is a switch module (18) having at least one switch (22) for operating a vehicle facility.

8. The function module according to claim 6, characterized in that the function module is an electronic module (20).

9. The function module according to claim 6 , characterized in that a contact lead (36) of the function module (18, 20) is guided into the region of the plug-in contour (24).

10. The function module according to claim 9, characterized in that one end (38) of the contact lead (36) is bared and fastened in the region of the plug-in contour (24).

11. An assembly of a generator carrier (10) for a driver's gas bag module, and of a function module (18, 20) for a steering wheel of a motor vehicle, the generator carrier (10) having an outer wall (14), at least one insert contour (16) being provided for the arrangement of the function module (18, 20), the function module (18, 20) having a plug-in contour for fastening to the generator carrier (10).

12. The assembly according to claim 11, characterized in that on the outer wall (14) a cable harness (26) is guided for the electrical connection of the function module (18, 20).

13. The assembly according to claim 11, characterized in that inside the generator carrier (10) a cable harness (30) is laid, which is guided into the region of the insert contour (16).

14. The assembly according to claim 12, characterized in that one end (34) of the cable line (30) is bared and fastened in the region of the insert contour (16).

15. The assembly according to claim 13, characterized in that one end (34) of the cable line (30) is bared and fastened in the region of the insert contour (16).

16. The assembly according to claim 15, characterized in that a contact lead (36) of the function module (18, 20) is guided into the region of the plug-in contour (24).

17. The assembly according to claim 16, characterized in that one end (38) of the contact lead (36) is bared and fastened in the region of the plug-in contour (24).

18. The assembly according to claim 11, characterized in that at least one cable harness (26; 30) or one contact lead (28) is formed by three-dimensional vaporization.

19. The assembly according to claim 11, characterized in that the plug-in contour (24) of the function module (18, 20) is inserted into the insert contour (16) of the generator carrier (10) and the connection, thus produced, of the function module (18, 20) to the generator carrier (10) is secured by a detent mechanism.

20. A steering wheel for a motor vehicle, comprising an assembly of a generator carrier (10) for a driver's gas bag module, and of a function module (18, 20) for a steering wheel of a motor vehicle, the generator carrier (10) having an outer wall (14), at least one insert contour (16) being provided for the arrangement of the function module (18, 20), the function module (18, 20) having a plug-in contour for fastening to the generator carrier (10).
